(19) United States
(12) Patent Application Publication
(10) Pub. No.: US 2022/0084253 A1
(43) Pub. Date: Mar. 17, 2022

(54) METHOD AND DEVICE FOR COMPRESSING THREE-DIMENSIONAL DATA, AND METHOD AND DEVICE FOR RECONSTRUCTING THREE-DIMENSIONAL DATA

(71) Applicant: Samsung Electronics Co., Ltd., Suwon-si, Gyeonggi-do (KR)

(72) Inventors: Jihwan WOO, Suwon-si (KR); Youngho OH, Suwon-si (KR); Sungryeul RHYU, Suwon-si (KR)

(21) Appl. No.: 17/419,951

(22) PCT Filed: Jan. 3, 2020
(86) PCT No.: PCT/KR2020/000149

§ 371 Date: Jun. 30, 2021

(30) Foreign Application Priority Data
Jan. 3, 2019 (KR) 10-2019-0000865

(51) Int. Cl. G06T 9/00; G06T 5/00; G06T 5/50; G06T 7/246; G06T 17/20

(52) U.S. Cl. CPC G06T 9/001; G06T 5/002; G06T 2207/20224; G06T 7/251; G06T 17/205; G06T 5/50

(57) ABSTRACT

Provided is a three-dimensional (3D) data processing method for effectively removing noise occurring in a procedure of compressing and restoring 3D data. A 3D data compressing method according to an embodiment may include: generating a geometry image indicating position information of points, by projecting the points onto a two-dimensional (2D) plane, the points being included in 3D original data; compressing the geometry image; generating 3D reconstructed data by decompressing and reconstructing the compressed geometry image; compensating the 3D reconstructed data, based on the 3D original data; generating and compressing a texture image, based on the compensated 3D reconstructed data and color information of the points included in the 3D original data; and outputting the compressed geometry image, the compressed texture image, and compensation information related to the compensating of the 3D reconstructed data.

### TECHNICAL FIELD

The disclosure relates to a method and device for processing three-dimensional (3D) data.

### BACKGROUND ART

A point cloud refers to a set of a huge amount of points, and a large amount of three-dimensional (3D) data may be expressed as a point cloud. A point cloud is a method of expressing one point in a 3D space, and has a vector format capable of including both position coordinates and color. For example, the point cloud may be expressed as (x, y, z, R, G, B). When a density of the point cloud in which many colors and position datum are gathered to form a spatial configuration is increased, the point cloud develops to be more specific data and thus becomes one meaningful 3D model.

Because the point cloud expressing 3D data occupies a large amount of memory and a processor resource, there is a demand for a method of compressing the point cloud so as to transmit the point cloud. Accordingly, noise may occur in a procedure of compressing and restoring the 3D data.

### DESCRIPTION OF EMBODIMENTS

### Technical Problem

There is a demand for a three-dimensional (3D) data processing method capable of effectively removing noise occurring in a procedure of compressing and restoring 3D data.

### Solution to Problem

According to an aspect of an embodiment of the disclosure, a method of compressing three-dimensional (3D) data may include: generating a geometry image indicating position information of points, by projecting the points onto a two-dimensional (2D) plane, the points being included in 3D original data; compressing the geometry image; generating 3D reconstructed data by decompressing and reconstructing the compressed geometry image; compensating the 3D reconstructed data, based on the 3D original data; generating and compressing a texture image, based on the compensated 3D reconstructed data and color information of the points included in the 3D original data; and outputting the compressed geometry image, the compressed texture image, and compensation information related to the compensating of the 3D reconstructed data.

According to an aspect of an embodiment of the disclosure, a method of reconstructing 3D data may include: obtaining, from a received bitstream, a geometry image, a texture image, and compensation information; generating 3D reconstructed data by reconstructing the geometry image; compensating the 3D reconstructed data, based on the compensation information; and generating 3D data, based on the compensated 3D reconstructed data and the texture image, and outputting the 3D data, and wherein the compensation information includes information about original data used to generate the geometry image.

According to an aspect of an embodiment of the disclosure, a 3D data compression device may include: at least one processor configured to generate a geometry image indicating position information of points, by projecting the points onto a 2D plane, the points being included in 3D original data, compress the geometry image, generate 3D reconstructed data by decompressing and reconstructing the compressed geometry image, compensate the 3D reconstructed data, based on the 3D original data, and generate and compress a texture image, based on the compensated 3D reconstructed data and color information of the points included in the 3D original data; and an output unit configured to output the compressed geometry image, the compressed texture image, and compensation information related to the compensating of the 3D reconstructed data.

According to an aspect of an embodiment of the disclosure, a 3D data reconstruction device may include: a receiver configured to receive a bitstream; and at least one processor configured to obtain, from the bitstream, a geometry image, a texture image, and compensation information, generate 3D reconstructed data by reconstructing the geometry image, compensate the 3D reconstructed data, based on the compensation information, generate 3D data, based on the compensated 3D reconstructed data and the texture image, and output the 3D data, and wherein the compensation information includes information about original data used to generate the geometry image.

According to an aspect of an embodiment of the disclosure, provided is a computer program product including one or more computer-readable recording media having stored therein a program for performing the method.

### Advantageous Effects of Disclosure

According to various embodiments of the disclosure, noise that may occur in a procedure of compressing and restoring three-dimensional (3D) data may be effectively removed.

### BRIEF DESCRIPTION OF DRAWINGS

FIG. 1 illustrates a structure of an encoder used to compress three-dimensional (3D) data.

FIG. 2 illustrates two-dimensional (2D) images generated by projecting 3D data onto a plane.

FIG. 3 is a block diagram of a 3D data compression device according to an embodiment of the disclosure.

FIG. 4 is a diagram for describing a method of compensating 3D reconstructed data according to an embodiment of the disclosure.

FIG. 5 is a diagram for describing a method of compensating 3D reconstructed data according to an embodiment of the disclosure.

FIG. 6 is a block diagram of a 3D data compression device according to an embodiment of the disclosure.

FIG. 7 illustrates a flowchart of a method of compressing 3D data according to an embodiment of the disclosure.

FIG. 8 is a flowchart of a method of compensating 3D reconstructed data according to an embodiment of the disclosure.

FIG. 9 is a block diagram of a 3D data reconstruction device according to an embodiment of the disclosure.

FIG. 10 is a flowchart of a method of reconstructing 3D data according to an embodiment of the disclosure.

### BEST MODE

According to an aspect of an embodiment of the disclosure, a method of compressing three-dimensional (3D) data may include: generating a geometry image indicating position information of points, by projecting the points onto a two-dimensional (2D) plane, the points being included in 3D original data; compressing the geometry image; generating 3D reconstructed data by decompressing and reconstructing the compressed geometry image; compensating the 3D reconstructed data, based on the 3D original data; generating and compressing a texture image, based on the compensated 3D reconstructed data and color information of the points included in the 3D original data; and outputting the compressed geometry image, the compressed texture image, and compensation information related to the compensating of the 3D reconstructed data.

### MODE OF DISCLOSURE

Hereinafter, the disclosure will now be described more fully with reference to the accompanying drawings for one of ordinary skill in the art to be able to perform the embodiments without any difficulty. The disclosure may, however, be embodied in many different forms and should not be construed as being limited to the embodiments set forth herein. In addition, portions irrelevant to the description of the disclosure will be omitted in the drawings for a clear description of the disclosure, and like reference numerals will denote like elements throughout the specification.

Some embodiments of the disclosure may be described in terms of functional block components and various processing operations. Some or all of such functional blocks may be implemented by any number of hardware and/or software components configured to perform the specified functions. For example, the functional blocks of the disclosure may be implemented by one or more microprocessors or may be implemented by circuit components for preset functions. Also, for example, the functional blocks of the disclosure may be implemented with various programming or scripting languages. The functional blocks may be implemented in algorithms that are executed on one or more processors. Also, the disclosure may employ any number of legacy techniques for electronics configuration, signal processing and/or data processing, and the like.

Furthermore, connecting lines or connectors between elements shown in drawings are intended to represent exemplary functional connection and/or physical or logical connection between the elements. It should be noted that many alternative or additional functional connections, physical connections or logical connections may be present in a practical device.

In the present specification, an “image” may include all of a still image, a moving picture, a video frame, and/or a video stream, and may include all of a two-dimensional (2D) frame and a three-dimensional (3D) frame. For example, the “image” may include a 3D frame expressed as a point cloud.

The term “image” throughout the present specification is used as a collective term for describing not only “image” itself but also for describing “picture”, “frame”, “field”, “slice”, or the like which are various shapes of a video or image information that may be known to the related field. For example, an “image” may refer to one of a plurality of pictures or a plurality of frames which constitute a video stream, or may refer to the entire video stream including the plurality of pictures or the plurality of frames.

Hereinafter, the disclosure will now be described in detail with reference to the attached drawings.

A 2D image may be expressed as a set of pixels having color values. A 3D image may be expressed as a set of voxels having color values. Image data expressed as a set of points (or voxels) each having a color value in a 3D space is referred to as a point cloud. The point cloud includes information on the 3D space, and thus, consists of vectors of one-level higher dimension and has a larger amount of data, compared with a 2D image. Accordingly, there are many high-efficient compression technology studies for rapidly, correctly, and efficiently providing a point cloud to a user.

MPEG-I Part 5 Point Cloud Compression (PCC) group of the Moving Picture Experts Group (MPEG) that is the international standardization organization performs standardization of technology related to point cloud compression. The point cloud compression technology may be divided into various categories according to characteristics of data. In various compression technologies, a method of converting a point cloud into a 2D image, and compressing the converted 2D image by using a legacy video compression technology (e.g., High Efficiency Video Coding (HEVC), etc.) is introduced to the standardization conference.

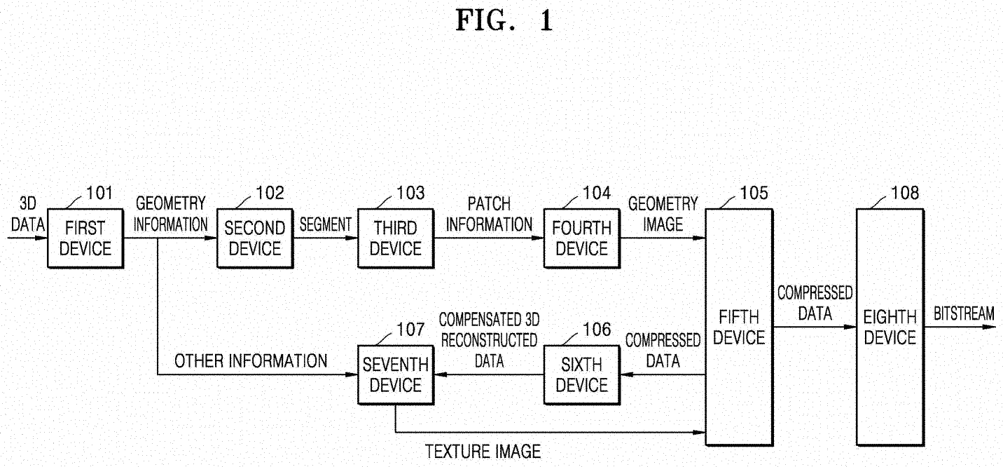

FIG. 1 illustrates a structure of an encoder used to compress 3D data.

A 3D data compression scheme that is currently used in the MPEG standard includes a scheme by which 3D data is generated as 2D data by projecting the 3D data onto a 2D plane, and the 2D data is compressed by using a 2D image compressing device. A decoder may decompress the compressed 2D data and may reversely perform a procedure of projecting the 3D data onto the 2D plane, the procedure having been performed by the encoder, such that the 3D data may be restored.

3D data according to an embodiment of the disclosure may include a point cloud image including at least one of position information, color information, and other attribute information which are about points in a 3D space.

A first device 101 of FIG. 1 may divide 3D data into geometry information including position information, and other attribute information about colors, and the like. For example, when the 3D data includes a point cloud image, the first device 101 may divide the point cloud image into geometry information indicating position coordinates of points, and other attribute information indicating colors.

A second device 102 may group the points by using at least one of proximity between the points and a geometrical characteristic of the points, based on the geometry information. For example, the geometrical characteristic of the points may include whether the points belong to a same plane and/or a direction of a normal vector of each point. The second device 102 may group the points included in the 3D data into a plurality of segments.

A third device 103 may project the segments onto a 2D plane. Each segment may be projected to a predefined plane, in consideration of geometry information of a point included in a corresponding segment. The third device 103 may generate patches by projecting each of the plurality of segments onto at least one 2D plane.

A fourth device 104 may combine the patches including 2D information projected to a plane, thereby generating a geometry image being processible by a 2D video encoder. The fourth device 104 may generate the geometry image by packing the patches.

For example, the encoder of FIG. 1 may use a predetermined surface thickness value so as to project a point cloud onto a plane. The encoder may perform projection only on points having a depth value within the predetermined surface thickness value from a surface. The encoder may generate a D0 image (position information image) by projecting a point positioned at a surface of an object indicated by a point cloud. The encoder may generate the D0 image (position information image) by collecting patches indicating depth values of points positioned at the surface of the object. The encoder may generate a D1 image (thickness information image) by projecting points having a largest depth value within the predetermined surface thickness value from the surface. The encoder may generate the D1 image (thickness information image) by collecting patches indicating the depth values of the points. The encoder may not store a depth value of an in-between point within the predetermined surface thickness value from the surface of the object.

A geometry image indicating position information of points included in a point cloud may include the D0 image and the D1 image that are described above.

A fifth device 105 may compress 2D image information. The fifth device 105 may compress the geometry image generated by the fourth device 104. For example, the fifth device 105 may compress 2D image information by using a legacy video compression technology including HEVC or the like.

A sixth device 106 may decompress the compressed 2D geometry image, and then may reconstruct the decompressed geometry image to 3D data, in consideration of a procedure performed by the second device 102, the third device 103, and the fourth device 104.

The sixth device 106 may perform smoothing to remove noise occurring in compression and restoration in a procedure of reconstructing the compressed 2D image to the 3D data. Noise may be added to data in a procedure of compressing and restoring the data, such that actual information may be distorted. Therefore, the sixth device 106 may compensate reconstructed 3D geometry information, in consideration of information of neighboring points of a point included in the reconstructed 3D data. The reconstructed 3D geometry information may be compensated by weight-averaging position values of 3D points whose Euclidean distances are within a range smaller than a predefined distance value. A weight used in the weight-averaging may be predefined by a user.

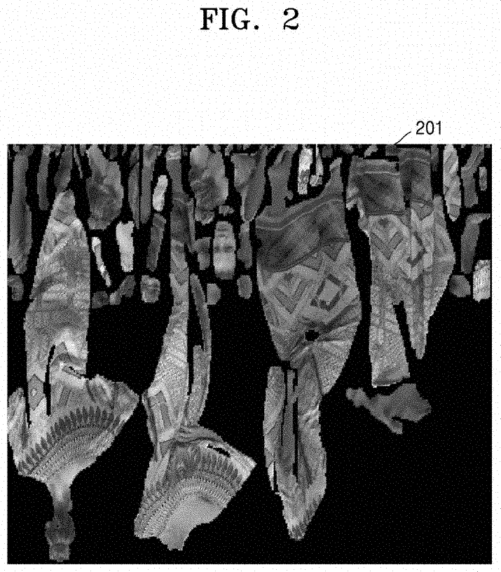

A seventh device 107 may generate a packing image by using the reconstructed 3D data and other attribute (e.g., color information), by using a similar method performed on the other attribute by the second device 102, the third device 103, and the fourth device 104. For example, as in a texture image 201 shown in FIG. 2, the seventh device 107 may generate a texture image indicating color information of points included in a point cloud. The texture image generated by the seventh device 107 may be expressed as compressed information after undergoing the fifth device 105.

An eighth device 108 may output compressed geometry information and compressed other attribute information. For example, the eighth device 108 may transmit a bitstream including the compressed geometry information and the compressed other attribute information to a distant receiving end.

When the sixth device 106 removes noise occurring in compression and restoration, a method of compensating data by using an average of position values of points included in the reconstructed 3D data may cause image deterioration because noise may be included in neighboring points used in calculation of the average. Therefore, there is a demand for a method capable of effectively removing noise occurring in a procedure of compressing and restoring 3D data.

Hereinafter, a method and device for further effectively removing noise according to various embodiments of the disclosure will now be described.

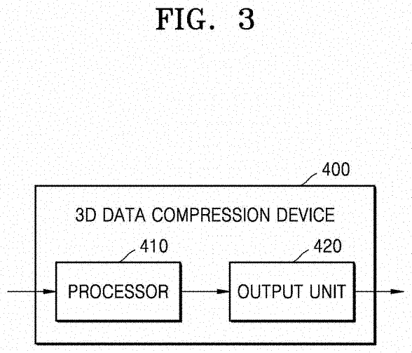

FIG. 3 is a block diagram of a 3D data compression device according to an embodiment of the disclosure. A 3D data compression device 400 according to an embodiment of the disclosure may be a 3D image encoding device for encoding a 3D image.

As illustrated in FIG. 3, the 3D data compression device 400 according to an embodiment of the disclosure may include a processor 410 and an output unit 420. The processor 410 of the 3D data compression device 400 according to an embodiment may obtain and encode 3D data. The processor 410 of the 3D data compression device 400 may generate a compressed bitstream by processing the 3D data. The output unit 420 of the 3D data compression device 400 may output the bitstream of the compressed 3D data information. For example, the output unit 420 of the 3D data compression device 400 may transmit the bitstream to an image decoding device (or a 3D data reconstruction device) via a network, or may store the bitstream in the 3D data compression device 400.

Hereinafter, a method by which the processor 410 of the 3D data compression device 400 processes 3D data according to an embodiment will now be described in detail. In FIG. 3, it is illustrated that the 3D data compression device 400 includes one processor 410 but the disclosure is not limited to the embodiment of FIG. 3. The 3D data compression device 400 according to an embodiment of the disclosure may include a plurality of processors, and operations to be described below may be performed by the plurality of processors.

The processor 410 of the 3D data compression device 400 according to an embodiment may generate a geometry image indicating position information of points, by projecting the points onto a 2D plane, the points being included in 3D original data.

The processor 410 may group the points included in the 3D original data into a plurality of segments. The processor 410 may generate patches by projecting the plurality of segments onto the 2D plane. The processor 410 may generate the geometry image by packing the patches in at least one frame. The processor 410 may divide the patches according to similarities, and may collect and pack divided patches, thereby generating the geometry image. The geometry image may indicate position information of the points included in a point cloud.

The processor 410 according to an embodiment may compress the geometry image. The processor 410 may compress the geometry image by using a 2D image compression codec.

The processor 410 according to an embodiment may generate 3D reconstructed data by decompressing and reconstructing the compressed geometry image. The processor 410 may decompress and reconstruct the compressed geometry image, in consideration of a procedure previously performed to generate the compressed geometry image.

The processor 410 according to an embodiment may compensate the 3D reconstructed data, based on the 3D original data.

The processor 410 may perform smoothing for removing noise of the 3D reconstructed data, by comparing the 3D original data with the 3D reconstructed data. The processor 410 may perform smoothing on all points included in the 3D reconstructed data, or may select some points and perform smoothing on the selected points.

For example, the processor 410 may not perform smoothing on all points so as to reduce a computation time consumed to perform smoothing, but may select a point according to a reference predefined by a user or may select a point having a large deviation, as a result of comparison with the 3D original data.

The processor 410 may select an area from which noise should be removed in a procedure of grouping points included in the 3D original data into a plurality of segments, generating patches, and generating the geometry image.

For example, in a procedure of generating the plurality of segments, the processor 410 may determine, as a noise removal priority area, an area having a large difference from neighboring points, in consideration of geometry information of the points. Alternatively, the processor 410 may determine, as a noise removal priority area, at least one area among a user-defined area, an outer area of a patch, an area having a high probability of degradation due to noise on a patch, and a boundary area between patches. Alternatively, the processor 410 may determine a noise removal priority area, according to a distribution characteristic of the 3D original data.

The processor 410 according to an embodiment may compensate the 3D reconstructed data according to methods below.

In an example, the processor 410 may track how neighboring points included in the 3D original data have been changed in a compression and restoration procedure, and may compensate the 3D reconstructed data by using such tracked data. For example, the processor 410 may calculate a weighted average of the tracked points, and may compensate the 3D reconstructed data by using the calculated value.

The processor 410 may not select, from the 3D reconstructed data, points to be used in smoothing the 3D reconstructed data, but may select, from the 3D original data, points to be used in smoothing the 3D reconstructed data.

First, the processor 410 may select a reference reconstruction point Xr(i) from reconstruction points included in the 3D reconstructed data, and may determine a reference original point Xo(i) corresponding to the reference reconstruction point Xr(i) from among original points included in the 3D original data. The processor 410 may track the reference original point Xo(i) corresponding to the reference reconstruction point Xr(i), by reversely using information used in the procedure of grouping points included in the 3D original data into the plurality of segments, generating the patches, and generating the geometry image.

The processor 410 may determine, from the 3D original data, neighboring original points N(Xo(i)) of the reference original point Xo(i).

When determining points to be used in smoothing, the processor 410 may select points located within a preset distance from the reference original point Xo(i), a user-defined number (e.g., 100) of points located around the reference original point Xo(i), or points included in a boundary determined according to a density of neighboring points of the reference original point Xo(i), or may select points that satisfy a combined condition. Also, the processor 410 may check a similarity between attributes of points, and may select points with a high similarity as points to be used in smoothing.

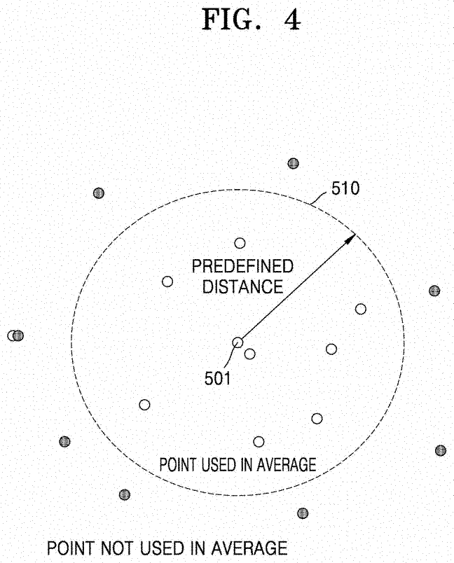

For example, as illustrated in FIG. 4, the processor 410 may determine a reference original point Xo(i) 501 from among points included in the 3D original data, and may determine, as neighboring original points N(Xo(i)), points within a predefined distance from the reference original point Xo(i) 501.

The processor 410 may track neighboring reconstruction points N(Xo(i)r) corresponding to the neighboring original points N(Xo(i)). For the neighboring original points N(Xo(i)), the processor 410 may track, as the neighboring reconstruction points N(Xo(i)r), points that are obtained by compressing and then restoring the neighboring original points N(Xo(i)).

The processor 410 may update the reference reconstruction point Xr(i), based on the tracked neighboring reconstruction points N(Xo(i)r) and the reference reconstruction point Xr(i).

The processor 410 may compare an attribute of the tracked neighboring reconstruction points N(Xo(i)r) with an attribute of the reference reconstruction point Xr(i), and when a difference is equal to or greater than a threshold, the processor 410 may not use the tracked neighboring reconstruction points N(Xo(i)r) when the processor 410 calculates an update value of the reference reconstruction point Xr(i). An attribute of a point may include a color corresponding to the point, a direction of a normal vector of the point, a plane on which the point is located, a segment to which the point belongs, or the like. Alternatively, an attribute similarity and/or a distance similarity between a neighboring point N(Xr(i) of the reference reconstruction point Xr(i) and the tracked neighboring reconstruction points N(Xo(i)r) may be compared, and when a difference is equal to or greater than a threshold, the tracked neighboring reconstruction points N(Xo(i)r) may be excluded from a noise smoothing procedure. For example, the attribute similarity may include a similarity in a color space.

For example, the processor 410 may determine whether to update the reference reconstruction point Xr(i), based on a distance between the tracked neighboring reconstruction points N(Xo(i)r) and the reference reconstruction point Xr(i). When a distance difference between the tracked neighboring reconstruction points N(Xo(i)r) and the reference reconstruction point Xr(i) is smaller than the threshold, the processor 410 may update the reference reconstruction point Xr(i). When the distance difference between the tracked neighboring reconstruction points N(Xo(i)r) and the reference reconstruction point Xr(i) is equal to or greater than the threshold, the processor 410 may not update the reference reconstruction point Xr(i).

The processor 410 may update the reference reconstruction point Xr(i) by using a weight-averaging method using a weight being inversely proportional to a color difference or the distance difference between the tracked neighboring reconstruction points N(Xo(i)r) and the reference reconstruction point Xr(i). Therefore, the attribute of the tracked neighboring reconstruction points N(Xo(i)r) and the attribute of the reference reconstruction point Xr(i) may be applied in updating the 3D reconstructed data. In calculation of the weight, the processor 410 may consider a similarity for each channel on a color space, and may increase the weight when the similarity is high. The processor 410 may calculate the weight by simultaneously considering both a color similarity on the color space and a distance similarity on a geometry space.

In another example, the processor 410 may quantitatively compare geometry information of points included in the 3D original data with geometry information of points included in the 3D reconstructed data (e.g., comparing distances between the points), and then may perform fitting to allow points to exist on a curved line or a curved surface of an area where a deviation is equal to or greater than a threshold. Information for the fitting (e.g., the number of fitted points, a position on which the fitting is performed, and a coefficient required to perform the fitting on the curved line or the curved surface) may be transmitted in the form of metadata to a decoder.

In detail, the processor 410 may compare the 3D original data with the 3D reconstructed data, thereby detecting points that are included in the 3D original data but are not included in the 3D reconstructed data. The processor 410 may determine the curved line or the curved surface, based on the points detected from the 3D original data, and may compensate the 3D reconstructed data, based on the determined curved line or curved surface.

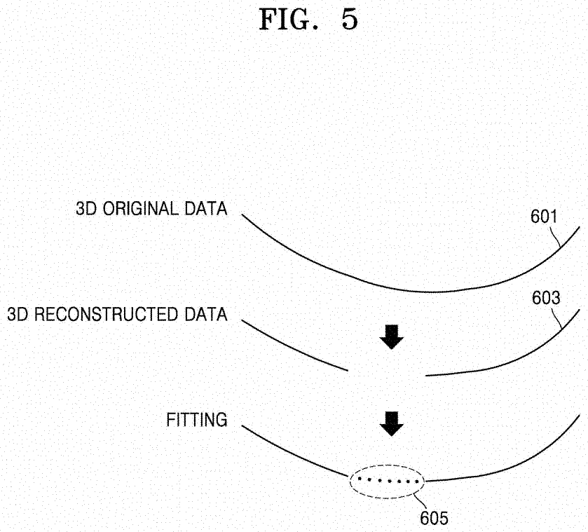

For example, as illustrated in FIG. 5, the processor 410 may compare 3D original data 601 with 3D reconstructed data 603, thereby detecting points 605 that are included in the 3D original data but are not included in the 3D reconstructed data. A curved line or a curved surface with respect to the points 605 are fitted, such that the curved line or the curved surface for compensating the 3D reconstructed data may be determined.

Information about the determined curved line or curved surface may be output as compensation information through the output unit 420. For example, the information about the determined curved line or curved surface may include information about at least one of a coefficient of an equation indicating the determined curved line or curved surface, the number of detected points, and a position of the determined curved line or curved surface. For example, a curved line or a curved surface may be expressed as a quadratic equation of ax\hat{ }2+bx+cxy+dy\hat{ }2+ey+f=0, and information about coefficients of a, b, c, d, e, f included in the quadratic equation may be transmitted to the decoder.

After the 3D reconstructed data is compensated according to the aforementioned method, the processor 410 according to an embodiment may generate and compress a texture image, based on color information of points included in the compensated 3D reconstructed data and the 3D original data.

The processor 410 may generate the texture image of a plurality of packed patches by projecting the color information of the points included in the compensated 3D reconstructed data onto a 2D plane, based on information about the patches constituting a geometry image. The texture image may indicate color information of points included in a point cloud.

The processor 410 according to an embodiment may compress the texture image. The processor 410 may compress the texture image by using a 2D image compression codec.

The processor 410 may compress geometry images and texture images by using a 2D image compression technology, and may further compress an occupancy map and auxiliary data. The occupancy map may include information for distinguishing between a pixel having information about a point cloud and a pixel not having the information from among pixels of a 2D image when data related to the point cloud is converted into the 2D image. The auxiliary data may include patch information and compensation information.

The output unit 420 according to an embodiment may output the compressed geometry image, the compressed texture image, and the compensation information related to the compensation of the 3D reconstructed data. The output unit 420 may include a multiplexer for outputting a bitstream including the compressed geometry image, the compressed texture image, the compressed occupancy map, and the compressed auxiliary data.

The output unit 420 may output a bitstream including the compensation information in the form of metadata, the compressed geometry image and the compressed texture image. The compensation information may be used to restore 3D data. For example, the output unit 420 according to an embodiment may add a difference to metadata and output the metadata, the difference between coordinates of points included in the 3D reconstructed data and coordinates of points included in the 3D original data.

For example, the compensation information may include at least one of information about at least one point included in the 3D original data used to compensate the 3D reconstructed data, information about a corresponding relation between the 3D original data and the 3D reconstructed data, noise removal priority area information included in the 3D reconstructed data, and information about a curved line or a curved surface used to compensate the 3D reconstructed data. For example, the compensation information may include information about neighboring original points N(Xo(i)) corresponding to a reference reconstruction point Xr(i) and/or information about tracked neighboring reconstruction points N(Xo(i)r).

As another example, the compensation information may include information about a curved line or a curved surface which is determined by the processor 410 by comparing the 3D original data with the 3D reconstructed data. For example, the information about the determined curved line or curved surface may include information about at least one of a coefficient of an equation indicating the determined curved line or curved surface, the number of detected points, and a position of the determined curved line or curved surface.

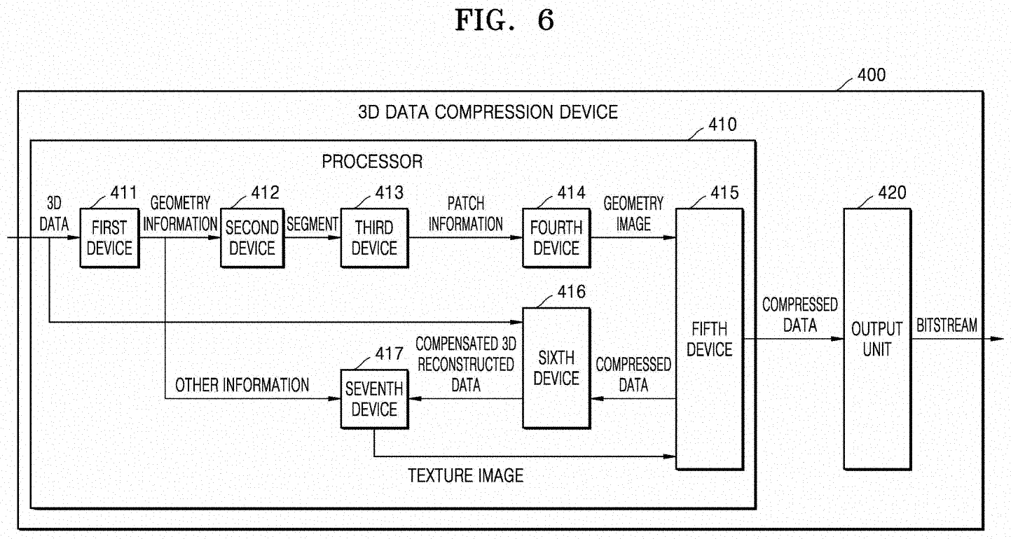

FIG. 6 is a block diagram of a 3D data compression device 400 according to an embodiment. As illustrated in FIG. 6, the processor 410 according to an embodiment may include a first device 411, a second device 412, a third device 413, a fourth device 414, a fifth device 415, a sixth device 416, and a seventh device 417. The first device 411, the second device 412, the third device 413, the fourth device 414, the fifth device 415, the sixth device 416, and the seventh device 417 may be hardware configurations, or function blocks implemented by the processor 410. Therefore, an operation of each configuration to be described below may be performed by the processor 410.

Descriptions of the first device 101, the second device 102, the third device 103, the fourth device 104, the fifth device 105, and the seventh device 107 of FIG. 1 may be applied to the first device 411, the second device 412, the third device 413, the fourth device 414, the fifth device 415, and the seventh device 417 of FIG. 6. Therefore, redundant descriptions are omitted.

In the 3D data compression device 400 according to an embodiment of the disclosure, the sixth device 416 may decompress a 2D geometry image compressed by the fifth device 415, and then may reconstruct the decompressed geometry image to 3D data, in consideration of a procedure performed by the second device 412, the third device 413, and the fourth device 414.

The sixth device 416 may perform smoothing to remove noise occurring in compression and restoration in a procedure of reconstructing the compressed 2D image to the 3D data. The sixth device 416 may perform smoothing for removing noise of 3D reconstructed data, by comparing 3D original data with the 3D reconstructed data. The sixth device 416 may perform smoothing on all points included in the 3D reconstructed data, or may select some points and perform smoothing on the selected points.

With respect to an area where a difference between the 3D original data and the 3D reconstructed data is small, the sixth device 416 may track how neighboring points included in the 3D original data have been changed in a compression and restoration procedure, and may compensate the 3D reconstructed data by using such tracked data. Alternatively, with respect to an area where a difference between the 3D original data and the 3D reconstructed data is large, the sixth device 416 may perform curved line or curved surface fitting on an area where points are not located in the 3D reconstructed data whereas the points are located in the 3D original data.

Descriptions of the processor 410 of FIG. 3 may be applied to a particular method by which the sixth device 416 according to an embodiment compensates the 3D reconstructed data, based on the 3D original data. Redundant descriptions are omitted.

The seventh device 107 may generate a texture image by using the reconstructed 3D data compensated by the sixth device 416 and other attribute (e.g., color information) data. The seventh device 107 may generate the texture image by using a similar method to a method performed by the second device 412, the third device 413, and the fourth device 414.

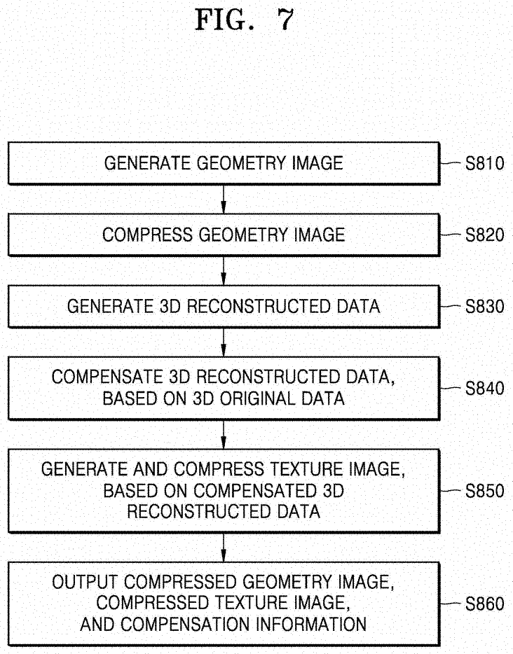

As described above, the 3D data compression device 400 according to an embodiment of the disclosure may remove, from compressed image information, noise occurring in a procedure of restoring 3D information, and may control a disposition of 3D points not to have sharp variation among spatially-neighboring points, such that image quality may be improved. Hereinafter, with reference to FIG. 7, a method by which the 3D data compression device 400 according to various embodiments compresses 3D data will now be described in detail.

FIG. 7 illustrates a flowchart of a method of compressing 3D data according to an embodiment of the disclosure. Each operation of the method to be described below may be performed by each configuration of the 3D data compression device 400 shown in FIGS. 3 and 6. Descriptions provided above with reference to the 3D data compression device 400 may be applied to each operation of methods below. Redundant descriptions are omitted.

In operation S810, the 3D data compression device 400 according to an embodiment may generate a geometry image indicating position information of points, by projecting the points onto a 2D plane, the points being included in 3D original data.

The 3D data compression device 400 may group the points included in the 3D original data into a plurality of segments. The 3D data compression device 400 may generate patches by projecting the plurality of segments onto the 2D plane. The 3D data compression device 400 may generate the geometry image by packing the patches.

In operation S820, the 3D data compression device 400 according to an embodiment may compress the geometry image.

In operation S830, the 3D data compression device 400 according to an embodiment may generate 3D reconstructed data by decompressing and reconstructing the compressed geometry image.

In operation S840, the 3D data compression device 400 according to an embodiment may compensate the 3D reconstructed data, based on the 3D original data.

The 3D data compression device 400 may perform smoothing for removing noise of the 3D reconstructed data, by comparing the 3D original data with the 3D reconstructed data.

For example, the 3D data compression device 400 may select a reference reconstruction point Xr(i) from among reconstruction points included in the 3D reconstructed data. The 3D data compression device 400 may determine a reference original point Xo(i) corresponding to the reference reconstruction point Xr(i), from among original points included in the 3D original data. The 3D data compression device 400 may determine neighboring original points N(Xo(i)) of the reference original point Xo(i). The 3D data compression device 400 may track neighboring reconstruction points N(Xo(i)r) corresponding to the neighboring original points N(Xo(i)). The 3D data compression device 400 may update the reference reconstruction point Xr(i), based on the tracked neighboring reconstruction points N(Xo(i)r) and the reference reconstruction point Xr(i).

When a distance difference between the tracked neighboring reconstruction points N(Xo(i)r) and the reference reconstruction point Xr(i) is smaller than a threshold, the 3D data compression device 400 may update the reference reconstruction point Xr(i). When the distance difference between the tracked neighboring reconstruction points N(Xo(i)r) and the reference reconstruction point Xr(i) is equal to or greater than the threshold, the 3D data compression device 400 may not update the reference reconstruction point Xr(i).

The 3D data compression device 400 may update the reference reconstruction point Xr(i) by using a weight-averaging method using a weight being inversely proportional to a color difference or the distance difference between the tracked neighboring reconstruction points N(Xo(i)r) and the reference reconstruction point Xr(i).

As another example, the 3D data compression device 400 may detect points included in the 3D original data but not included in the 3D reconstructed data, by comparing the 3D original data with the 3D reconstructed data. The 3D data compression device 400 may determine a curved line or a curved surface, based on the points detected from the 3D original data. The 3D data compression device 400 may approximate the curved line or the curved surface with respect to the points detected from the 3D original data.

The 3D data compression device 400 may compensate the 3D reconstructed data, based on the determined curved line or curved surface. Information about the determined curved line or curved surface may be included in compensation information and output. For example, the information about the determined curved line or curved surface may include information about at least one of a coefficient of an equation indicating the determined curved line or curved surface, the number of detected points, and a position of the determined curved line or curved surface.

In operation S850, the 3D data compression device 400 according to an embodiment may generate and compress a texture image, based on the compensated 3D reconstructed data and color information of the points included in the 3D original data.

The 3D data compression device 400 may generate the texture image of a plurality of packed patches by projecting the color information of the points included in the compensated 3D reconstructed data onto a 2D plane, based on information about the patches constituting the geometry image.

In operation S860, the 3D data compression device 400 according to an embodiment may output the compressed geometry image, the compressed texture image, and compensation information related to the compensation of the 3D reconstructed data.

The 3D data compression device 400 may include the compensation information in the form of metadata, and may output a bitstream including the compressed geometry image and the compressed texture image.

For example, the compensation information may include at least one of information about at least one point included in the 3D original data used to compensate the 3D reconstructed data, information about a corresponding relation between the 3D original data and the 3D reconstructed data, noise removal priority area information included in the 3D reconstructed data, and information about a curved line or a curved surface used to compensate the 3D reconstructed data. For example, the compensation information may include information about the determined curved line or curved surface. The information about the determined curved line or curved surface may include information about at least one of a coefficient of an equation indicating the determined curved line or curved surface, the number of detected points, and a position of the determined curved line or curved surface.

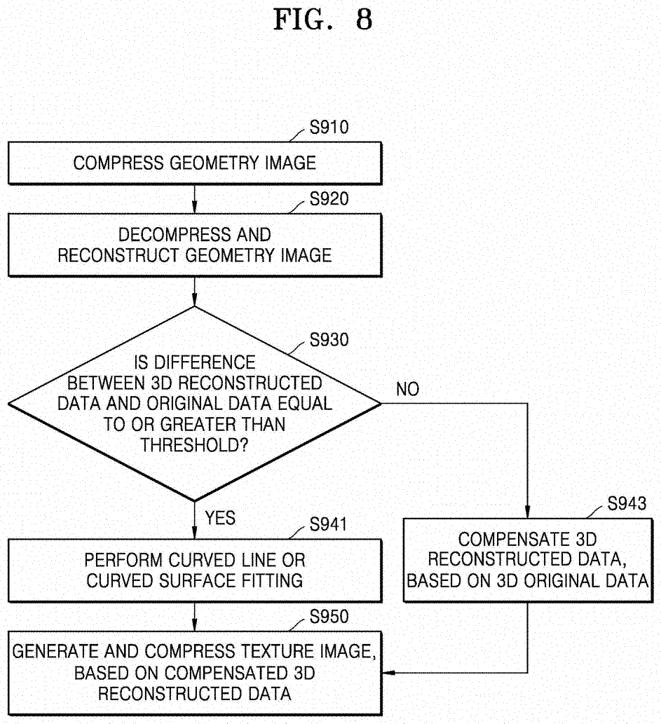

The 3D data compression device 400 according to an embodiment of the disclosure may compensate the 3D reconstructed data, based on a difference between the 3D original data and the 3D reconstructed data. FIG. 8 is a flowchart of a method of compensating 3D reconstructed data according to an embodiment of the disclosure. Each operation of the method to be described below may be performed by each configuration of the 3D data compression device 400 which is illustrated in FIGS. 3 and 6. Descriptions provided above with reference to the 3D data compression device 400 may be applied to each operation of methods below. Redundant descriptions are omitted.

Also, operation S910 of FIG. 8 may correspond to operation S820 of FIG. 7, operation S920 of FIG. 8 may correspond to operation S830 of FIG. 7, operations S930, S941, and S943 of FIG. 8 may correspond to operation S840 of FIG. 7, and operation S950 of FIG. 8 may correspond to operation S850 of FIG. 7. With respect to each operation of FIG. 8, descriptions of corresponding operation of FIG. 7 may be applied thereto.

In operation S910 of FIG. 8, the 3D data compression device 400 according to an embodiment may compress a geometry image.

In operation S920 of FIG. 8, the 3D data compression device 400 according to an embodiment may generate 3D reconstructed data by decompressing and reconstructing the compressed geometry image.

In operation S930 of FIG. 8, the 3D data compression device 400 according to an embodiment may determine whether a difference between the 3D reconstructed data and 3D original data is equal to or greater than a threshold.

When the difference between the 3D reconstructed data and the 3D original data is equal to or greater than the threshold, in operation S941 of FIG. 8, the 3D data compression device 400 according to an embodiment may perform curved line or curved surface fitting. The fitting may refer to detection of points included in the 3D original data but not included in the 3D reconstructed data, and determination of a curved line or curved surface which matches (or is similar to) the detected points.

When the difference between the 3D reconstructed data and the 3D original data is smaller than the threshold, in operation S943 of FIG. 8, the 3D data compression device 400 according to an embodiment may compensate the 3D reconstructed data, based on the 3D original data. The 3D data compression device 400 may track how neighboring points included in the 3D original data have been changed in a compression and restoration procedure, and may compensate the 3D reconstructed data by using the tracked data.

In operation S950 of FIG. 8, the 3D data compression device 400 according to an embodiment may generate and compress a texture image, based on the compensated 3D reconstructed data.

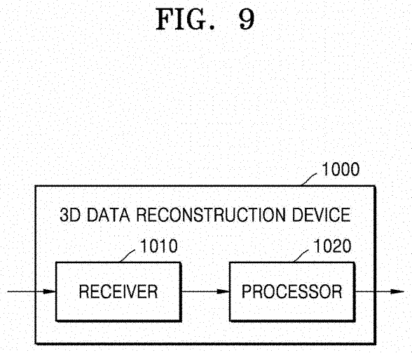

FIG. 9 is a block diagram of a 3D data reconstruction device according to an embodiment of the disclosure. A 3D data reconstruction device 1000 according to an embodiment of the disclosure may be a 3D image decoding device for decoding an encoded 3D image and outputting the decoded 3D image.

As illustrated in FIG. 9, the 3D data reconstruction device 1000 according to an embodiment may output a 3D image by receiving a bitstream and then processing the bitstream. As illustrated in FIG. 9, the 3D data reconstruction device 1000 according to an embodiment may include a receiver 1010 and a processor 1020.

The receiver 1010 of the 3D data reconstruction device 1000 according to an embodiment may receive the bitstream of compressed 3D data information. For example, the receiver 1020 of the 3D data reconstruction device 1000 may receive the bitstream from an image encoding device (or, a 3D compression reconstruction device) via a network, or may obtain the bitstream stored therein.

The processor 1020 of the 3D data reconstruction device 1000 according to an embodiment may obtain, from the received bitstream, and decode compressed and encoded 3D data. The processor 1020 may generate a 3D image (or, 3D point cloud data) by reconstructing the encoded 3D data, and may output the 3D image. The processor 1020 of the 3D data reconstruction device 1000 according to an embodiment may output the 3D image including a plurality of 3D frames reconstructed from the bitstream. For example, the processor 1020 may output the 3D image on a display, based on 3D reconstructed data.

Hereinafter, a method by which the processor 1020 of the 3D data reconstruction device 1000 according to an embodiment processes 3D data will now be described in detail. FIG. 9 illustrates that the 3D data reconstruction device 1000 includes one processor 1020, but the disclosure is not limited to the embodiment illustrated in FIG. 9. The 3D data reconstruction device 1000 according to an embodiment of the disclosure may include a plurality of processors, and operations to be described below may be performed by the plurality of processors.

The processor 1020 according to an embodiment may obtain compressed 3D data from a bitstream. The processor 1020 may decompress the compressed 3D data. The processor 1020 may obtain a geometry image, a texture image, and compensation information, by decompressing data included in the bitstream. The processor 1020 may obtain, from the bitstream, auxiliary information including the compensation information. The processor 1020 may further include an occupancy map from the bitstream.

For example, the processor 1020 may include a demultiplexer (DE-MUX) for obtaining, from a bitstream, a compressed geometry image, a compressed texture image, a compressed occupancy map, and compressed auxiliary information when the bitstream is received. The processor 1020 may include a decompressor for decompressing a plurality of pieces of compressed information.

The processor 1020 may generate 3D reconstructed data by reconstructing the geometry image. Based on a decompressed geometry image, a decompressed occupancy map, and decompressed auxiliary information, the processor 1020 may generate the 3D reconstructed data in which points are disposed in a 3D space.

The processor 1020 may perform smoothing for removing noise so as to minimize an error occurring due to compression and restoration of the 3D data. The processor 1020 may compensate the 3D reconstructed data, based on compensation information. The compensation information may include information about original data used to generate the geometry image. The compensation information used by the processor 1020 of the 3D data reconstruction device 1000 according to an embodiment may be equal to the compensation information generated by the 3D data compression device 400.

For example, the 3D data compression device 400 may generate the compensation information to include at least one of information about at least one point included in the 3D original data used to compensate the 3D reconstructed data, information about a corresponding relation between the 3D original data and the 3D reconstructed data, noise removal priority area information included in the 3D reconstructed data, and information about a curved line or a curved surface used to compensate the 3D reconstructed data. For example, the compensation information may include information about neighboring original points N(Xo(i)) corresponding to a reference reconstruction point Xr(i) and/or information about tracked neighboring reconstruction points N(Xo(i)r).

As another example, the compensation information may include information about a curved line or a curved surface which is determined by the processor 410 of the 3D data compression device 400 by comparing the 3D original data with the 3D reconstructed data. For example, the information about the determined curved line or curved surface may include information about at least one of a coefficient of an equation indicating the determined curved line or curved surface, the number of detected points, and a position of the determined curved line or curved surface.

Also, the processor 1020 of the 3D data reconstruction device 1000 according to an embodiment may compensate the 3D reconstructed data in a same scheme to a 3D reconstructed data compensation procedure performed by the processor 410 of the 3D data compression device 400 of FIG. 3. Therefore, redundant descriptions are omitted.

The processor 1020 may generate 3D data, based on the compensated 3D reconstructed data and a texture image, and may output the 3D data. The processor 1020 may generate the 3D data by applying color information of points included in the texture image to points included in the compensated 3D reconstructed data. The generated 3D data may be in the form of a point cloud.

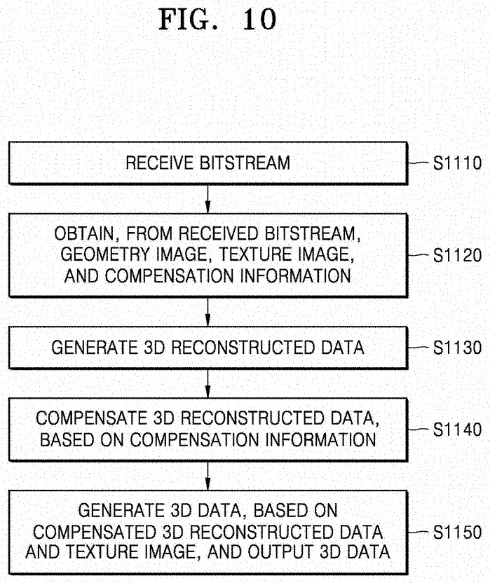

As described above, the 3D data reconstruction device 1000 according to an embodiment of the disclosure may equally perform a noise removal procedure performed by the 3D data compression device 400, such that the 3D data reconstruction device 1000 may remove, from compressed image information, noise occurring in a procedure of restoring 3D information, and may control a disposition of 3D points not to have sharp variation among spatially-neighboring points, such that image quality may be improved. Hereinafter, with reference to FIG. 10, a method by which the 3D data reconstruction device 1000 according to various embodiments reconstructs 3D data will now be described in detail.

FIG. 10 is a flowchart of a method of reconstructing 3D data according to an embodiment of the disclosure. Each operation of the method to be described below may be performed by each configuration of the 3D data reconstruction device 1000 which is illustrated in FIG. 9. Descriptions provided above with reference to the 3D data reconstruction device 1000 may be applied to each operation of methods below. Redundant descriptions are omitted.

In operation S1110, the 3D data reconstruction device 1000 according to an embodiment may receive a bitstream.

In operation S1120, the 3D data reconstruction device 1000 according to an embodiment may obtain, from the received bitstream, a geometry image, a texture image, and compensation information.

In operation S1130, the 3D data reconstruction device 1000 according to an embodiment may generate 3D reconstructed data by reconstructing the geometry image.

In operation S1140, the 3D data reconstruction device 1000 according to an embodiment may compensate the 3D reconstructed data, based on the compensation information.

In operation S1150, the 3D data reconstruction device 1000 according to an embodiment may generate 3D data, based on the compensated 3D reconstructed data and the texture image, and may output the 3D data.

The disclosed embodiments may be implemented in a software (S/W) program including instructions stored in a computer-readable storage medium.

The computer is a device capable of retrieving the stored instructions from the storage medium and operating according to the disclosed embodiments in accordance with the retrieved instructions, and may include an image transmission device and an image reception device according to the disclosed embodiments.

The computer-readable storage medium may be provided in the form of a non-transitory storage medium. Here, the term ‘non-transitory’ means that the storage medium is tangible and does not refer to a transitory electrical signal, but does not distinguish that data is stored semi-permanently or temporarily on the storage medium.

Furthermore, an electronic device or a method according to the disclosed embodiments may be provided in a computer program product. The computer program product may be traded between a seller and a purchaser as a commodity.

The computer program product may include an S/W program and a computer-readable storage medium having stored thereon the S/W program. For example, the computer program product may include a product (e.g. a downloadable application) in an S/W program distributed electronically through a manufacturer of an electronic device or an electronic market (e.g., Google Play Store and App Store). For electronic distribution, at least a part of the S/W program may be stored on the storage medium or may be generated temporarily. In this case, the storage medium may be a storage medium of a server of the manufacturer, a server of the electronic market, or a relay server for temporarily storing the S/W program.

In a system including a server and a terminal (e.g., a 3D data processing device, a 3D data reconstruction device, an image transmission device, or an image reception device), the computer program product may include a storage medium of the server or a storage medium of the terminal. Alternatively, when there is a third device (e.g., a smartphone) that communicates with the server or the terminal, the computer program product may include a storage medium of the third device. Alternatively, the computer program product may include an S/W program that is transmitted from the server to the terminal or the third device or from the third device to terminal.

In this case, one of the server, the terminal, and the third device may perform the method according to the disclosed embodiments by executing the computer program product. Alternatively, at least two of the server, the terminal, and the third device may divide and perform the method according to the disclosed embodiments by executing the computer program product.

For example, the server (e.g., a cloud server, an AI server, or the like) may execute the computer program product stored in the server, thereby controlling the terminal to perform the method according to the disclosed embodiments, the terminal communicating with the server.

As another example, the third device may execute the computer program product, thereby controlling the terminal to perform the method according to the disclosed embodiments, the terminal communicating with the third device. In a particular example, the third device may remotely control a 3D data compression device or the 3D data reconstruction device to transmit or receive a packing image.

When the third device executes the computer program product, the third device may download the computer program product from the server, and may execute the downloaded computer program product. Alternatively, the third device may perform the method according to the disclosed embodiments by executing a pre-loaded computer program product.

1. A method of compressing three-dimensional (3D) data, the method comprising:
generating a geometry image indicating position information of points, by projecting the points onto a two-dimensional (2D) plane, the points being comprised in 3D original data;
compressing the geometry image;
generating 3D reconstructed data by decompressing and reconstructing the compressed geometry image;
compensating the 3D reconstructed data, based on the 3D original data;
generating and compressing a texture image, based on the compensated 3D reconstructed data and color information of the points comprised in the 3D original data; and
outputting the compressed geometry image, the compressed texture image, and compensation information related to the compensating of the 3D reconstructed data.

2. The method of claim 1, wherein the compensating of the 3D reconstructed data comprises performing smoothing for removing noise of the 3D reconstructed data, by comparing the 3D original data with the 3D reconstructed data.

3. The method of claim 1, wherein the compensating of the 3D reconstructed data comprises:
detecting points comprised in the 3D original data but not comprised in the 3D reconstructed data, by comparing the 3D original data with the 3D reconstructed data;
determining a curved line or a curved surface, based on the points detected from the 3D original data; and
compensating the 3D reconstructed data, based on the determined curved line or curved surface, and
the compensation information comprises information about the determined curved line or curved surface.

4. The method of claim 3, wherein the information about the determined curved line or curved surface comprises information about at least one of a coefficient of an equation indicating the determined curved line or curved surface, the number of the detected points, and a position of the determined curved line or curved surface.

5. The method of claim 1, wherein the compensating of the 3D reconstructed data comprises:
selecting a reference reconstruction point Xr(i) from among reconstruction points comprised in the 3D reconstructed data;
determining a reference original point Xo(i) corresponding to the reference reconstruction point Xr(i), from among original points comprised in the 3D original data;
determining neighboring original points N(Xo(i)) of the reference original point Xo(i);
tracking neighboring reconstruction points N(Xo(i)r) corresponding to the neighboring original points N(Xo(i)); and
updating the reference reconstruction point Xr(i), based on the tracked neighboring reconstruction points N(Xo(i)r) and the reference reconstruction point Xr(i).

6. The method of claim 5, wherein the updating of the reference reconstruction point Xr(i) comprises:
when a distance difference between the tracked neighboring reconstruction points N(Xo(i)r) and the reference reconstruction point Xr(i) is smaller than a threshold, updating the reference reconstruction point Xr(i); and
when the distance difference between the tracked neighboring reconstruction points N(Xo(i)r) and the reference reconstruction point Xr(i) is equal to or greater than the threshold, maintaining the reference reconstruction point Xr(i).

7. The method of claim 5, wherein the updating of the reference reconstruction point Xr(i) comprises:
updating the reference reconstruction point Xr(i) by using a weight-averaging method using a weight being inversely proportional to a color difference or a distance difference between the tracked neighboring reconstruction points N(Xo(i)r) and the reference reconstruction point Xr(i).

8. The method of claim 1, wherein the generating of the geometry image comprises:
grouping the points comprised in the 3D original data into a plurality of segments;
generating patches by projecting the plurality of segments onto the 2D plane; and
generating the geometry image by packing the patches.

9. The method of claim 8, wherein the generating and compressing of the texture image comprises generating the texture image of the plurality of packed patches by projecting color information of points comprised in the compensated 3D reconstructed data onto the 2D plane, based on information about the patches constituting the geometry image.

10. The method of claim 1, wherein the compensation information comprises at least one of information about at least one point comprised in the 3D original data used to compensate the 3D reconstructed data, information about a corresponding relation between the 3D original data and the 3D reconstructed data, noise removal priority area information comprised in the 3D reconstructed data, and information about a curved line or a curved surface used to compensate the 3D reconstructed data, and
the outputting comprises outputting a bitstream comprising the compensation information in a form of metadata, the compressed geometry image and the compressed texture image.

11. A three-dimensional (3D) data compression device comprising:
at least one processor configured to generate a geometry image indicating position information of points, by projecting the points onto a two-dimensional (2D) plane, the points being comprised in 3D original data, compress the geometry image, generate 3D reconstructed data by decompressing and reconstructing the compressed geometry image, compensate the 3D reconstructed data, based on the 3D original data, and generate and compress a texture image, based on the compensated 3D reconstructed data and color information of the points comprised in the 3D original data; and
an output unit configured to output the compressed geometry image, the compressed texture image, and compensation information related to the compensating of the 3D reconstructed data.

12. The 3D data compression device of claim 11, wherein the at least one processor is configured to, in compensating the 3D reconstructed data, perform smoothing for removing noise of the 3D reconstructed data, by comparing the 3D original data with the 3D reconstructed data.

13. The 3D data compression device of claim 11, wherein the at least one processor is configured to, in compensating the 3D reconstructed data, detect points comprised in the 3D original data but not comprised in the 3D reconstructed data, by comparing the 3D original data with the 3D reconstructed data, determine a curved line or a curved surface, based on the points detected from the 3D original data, and compensate the 3D reconstructed data, based on the determined curved line or curved surface, and
the compensation information comprises information about the determined curved line or curved surface.

14. The 3D data compression device of claim 11, wherein the at least one processor is configured to, in compensating the 3D reconstructed data, select a reference reconstruction point Xr(i) from among reconstruction points comprised in the 3D reconstructed data, determine a reference original point Xo(i) corresponding to the reference reconstruction point Xr(i), from among original points comprised in the 3D original data, determine neighboring original points N(Xo(i)) of the reference original point Xo(i), track neighboring reconstruction points N(Xo(i)r) corresponding to the neighboring original points N(Xo(i)), and update the reference reconstruction point Xr(i), based on the tracked neighboring reconstruction points N(Xo(i)r) and the reference reconstruction point Xr(i).

15. A computer program product comprising a computer-readable recording medium having stored therein a program for performing the method of claim 1.
